(19) United States
(12) Patent Application Publication
(10) Pub. No.: US 2018/0106041 A1
(43) Pub. Date: Apr. 19, 2018

(54) LIGHTWEIGHT JACK

(71) Applicant: Felix Sorkin, Stafford, TX (US)

(72) Inventor: Felix Sorkin, Stafford, TX (US)

(21) Appl. No.: 15/596,261

(22) Filed: May 16, 2017

Related U.S. Application Data
(60) Provisional application No. 62/409,580, filed on Oct. 18, 2016.

(51) Int. Cl. E04C 5/12; E04C 5/07; E04C 5/01; B66F 3/36; B66F 3/28

(52) U.S. Cl. CPC E04C 5/122; E04C 5/073; B66F 3/28; B66F 3/36; E04C 5/012

(57) ABSTRACT

A lightweight jack includes a pressure cylinder, where the pressure cylinder has a pressure cylinder passage and a pressure cylinder body, the pressure cylinder body being a block through which a cylinder body passage is formed. The pressure cylinder is mechanically coupled to the pressure cylinder. The lightweight jack further includes a hydraulic actuator, where the hydraulic actuator is coupled to the pressure cylinder body. The hydraulic actuator includes an inner hydraulic cylinder, the inner hydraulic cylinder mechanically coupled to an inner cylinder head, and an outer cylinder, the outer cylinder mechanically coupled to an outer cylinder head. The lightweight jack also includes an extending body, the extending body coupled to the hydraulic actuator. The extending body is a block through which an extending body passage is formed, wherein the pressure cylinder passage, the cylinder body passage, and the extending body passage are aligned to form a tension member channel. The lightweight jack also includes a strand grabber, the strand grabber mechanically coupled to the extending body. The pressure cylinder, outer cylinder, and strand grabber are made of aluminum, titanium, fiber reinforced plastic, polymers, or carbon fiber.

### CROSS-REFERENCE TO RELATED APPLICATIONS

This application is a nonprovisional application which claims priority from U.S. provisional application No. 62/409,580, filed Oct. 18, 2016, which is hereby incorporated by reference in its entirety.

### TECHNICAL FIELD/FIELD OF THE DISCLOSURE

The present disclosure relates generally to equipment for post-tensioned, pre-stressed concrete construction.

### BACKGROUND OF THE DISCLOSURE

Many structures are built using concrete, including, for instance, buildings, parking structures, apartments, condominiums, hotels, mixed-use structures, casinos, hospitals, medical buildings, government buildings, research/academic institutions, industrial buildings, malls, roads, bridges, pavement, tanks, reservoirs, silos, sports courts, and other structures.

Prestressed concrete is structural concrete in which internal stresses are introduced to reduce potential tensile stresses in the concrete resulting from applied loads; prestressing may be accomplished by post-tensioned prestressing or pre-tensioned prestressing. In post-tensioned prestressing, a tension member is tensioned after the concrete has attained a desired strength by use of a post-tensioning tendon. The post-tensioning tendon may include for example and without limitation, anchor assemblies, the tension member, and sheathes.

Traditionally, a tension member is constructed of a material that can be elongated and may be a single or a multi-strand cable. The tension member may be formed from a metal, such as reinforced steel. The post-tensioning tendon traditionally includes an anchor assembly at each end. The tension member is fixedly coupled to a fixed anchor assembly positioned at one end of the post-tensioning tendon, the “fixed-end,” and stressed at the stressed anchor assembly positioned at the opposite end of the post-tensioning tendon, the “stressing-end” of the post-tensioning tendon.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a hydraulic pump consistent with certain embodiments of the present disclosure.

FIG. 2 depicts a lightweight jack consistent with certain embodiments of the present disclosure.

FIG. 3 depicts a front view of lightweight jack consistent with certain embodiments of the present disclosure.

FIG. 4 depicts a rear view of lightweight jack consistent with certain embodiments of the present disclosure.

FIG. 5 depicts a top view of lightweight jack consistent with certain embodiments of the present disclosure.

FIG. 6A depicts a cross-sectional view of lightweight jack in a partially extended state consistent with certain embodiments of the present disclosure.

FIG. 6B depicts a cross-sectional view of lightweight jack in an extended state consistent with certain embodiments of the present disclosure.

FIG. 6C depicts a cross-sectional view of lightweight jack in a retracted state consistent with certain embodiments of the present disclosure.

FIG. 7 is a schematic representation of a lightweight jack in position within a pocket in a concrete member.

### SUMMARY

A lightweight jack is disclosed. The lightweight jack includes a pressure cylinder, where the pressure cylinder has a pressure cylinder passage and a pressure cylinder body, the pressure cylinder body being a block through which a cylinder body passage is formed. The pressure cylinder is mechanically coupled to the pressure cylinder. The lightweight jack further includes a hydraulic actuator, where the hydraulic actuator is coupled to the pressure cylinder body. The hydraulic actuator includes an inner hydraulic cylinder, the inner hydraulic cylinder mechanically coupled to an inner cylinder head, and an outer cylinder, the outer cylinder mechanically coupled to an outer cylinder head. The lightweight jack also includes an extending body, the extending body coupled to the hydraulic actuator. The extending body is a block through which an extending body passage is formed, wherein the pressure cylinder passage, the cylinder body passage, and the extending body passage are aligned to form a tension member channel. The lightweight jack also includes a strand grabber, the strand grabber mechanically coupled to the extending body. The pressure cylinder, outer cylinder, and strand grabber are made of aluminum, titanium, fiber reinforced plastic, polymers, or carbon fiber.

A post-tensioning system is disclosed. The post-tensioning system includes a concrete member, the concrete member having a pocket and a stressing anchor positioned within the concrete member. The post-tensioning system also includes a tension member, the tension member passing through the stressing anchor; and a lightweight jack, the lightweight jack positioned so as to abut the anchor. The lightweight jack includes a pressure cylinder, where the pressure cylinder has a pressure cylinder passage and a pressure cylinder body, the pressure cylinder body being a block through which a cylinder body passage is formed. The pressure cylinder is mechanically coupled to the pressure cylinder. The lightweight jack further includes a hydraulic actuator, where the hydraulic actuator is coupled to the pressure cylinder body. The hydraulic actuator includes an inner hydraulic cylinder, the inner hydraulic cylinder mechanically coupled to an inner cylinder head, and an outer cylinder, the outer cylinder mechanically coupled to an outer cylinder head. The lightweight jack also includes an extending body, the extending body coupled to the hydraulic actuator. The extending body is a block through which an extending body passage is formed, wherein the pressure cylinder passage, the cylinder body passage, and the extending body passage are aligned to form a tension member channel. The lightweight jack also includes a strand grabber, the strand grabber mechanically coupled to the extending body. The pressure cylinder, outer cylinder, and strand grabber are made of aluminum, titanium, fiber reinforced plastic, polymers, or carbon fiber.

A method for post-tensioning a strand is disclosed. The method includes supplying a concrete member, the concrete member having a pocket and positioning a stressing anchor within the concrete member. The method also includes passing a tension member through the stressing anchor and positioning a lightweight jack in a retracted position about the tension member so as to abut the anchor. The lightweight jack includes a pressure cylinder, where the pressure cylinder has a pressure cylinder passage and a pressure cylinder body, the pressure cylinder body being a block through which a cylinder body passage is formed. The pressure cylinder is mechanically coupled to the pressure cylinder. The lightweight jack further includes a hydraulic actuator, where the hydraulic actuator is coupled to the pressure cylinder body. The hydraulic actuator includes an inner hydraulic cylinder, the inner hydraulic cylinder mechanically coupled to an inner cylinder head, and an outer cylinder, the outer cylinder mechanically coupled to an outer cylinder head. The lightweight jack also includes an extending body, the extending body coupled to the hydraulic actuator. The extending body is a block through which an extending body passage is formed, wherein the pressure cylinder passage, the cylinder body passage, and the extending body passage are aligned to form a tension member channel. The lightweight jack also includes a strand grabber, the strand grabber mechanically coupled to the extending body. The pressure cylinder, outer cylinder, and strand grabber are made of aluminum, titanium, fiber reinforced plastic, polymers, or carbon fiber. The method also includes engaging the tension member with the strand grabber and moving the lightweight jack from a retracted position to an extended position so as to tension the tension member.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

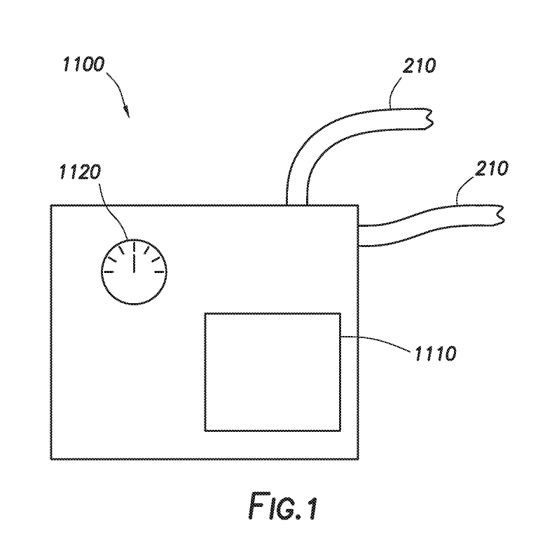

Certain embodiments of the present disclosure are directed to a lightweight jack for stressing a tension member. The lightweight jack may be hydraulically powered, such as through hydraulic fluid delivered by hydraulic pump 1100 having a hydraulic fluid source 1110, a pressure gauge 1120, and one or more hydraulic hoses 210, as depicted in FIG. 1.

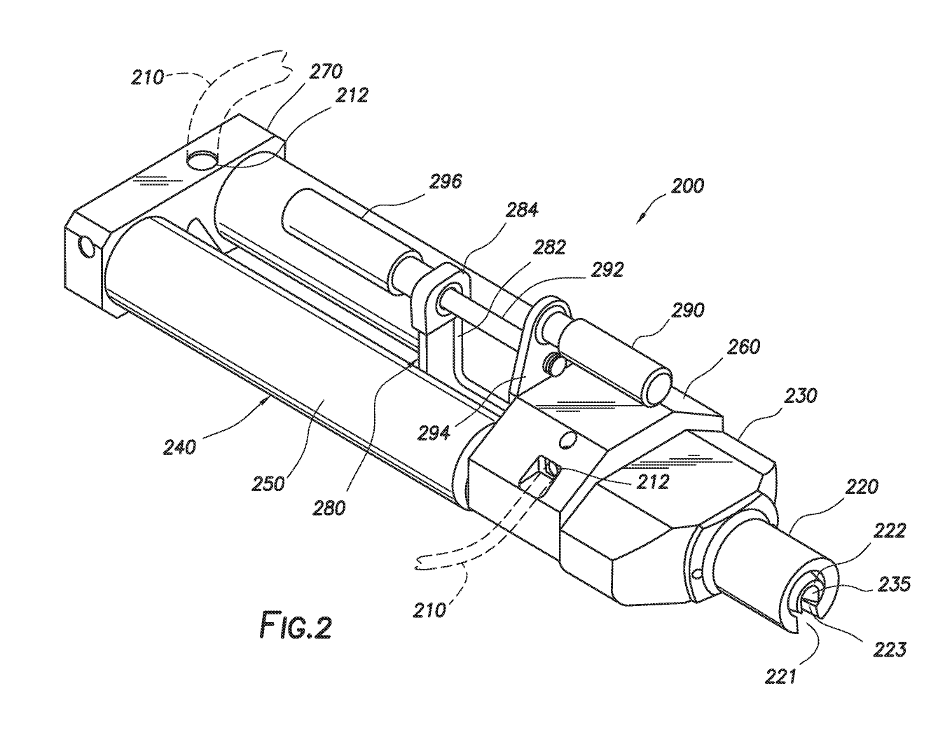

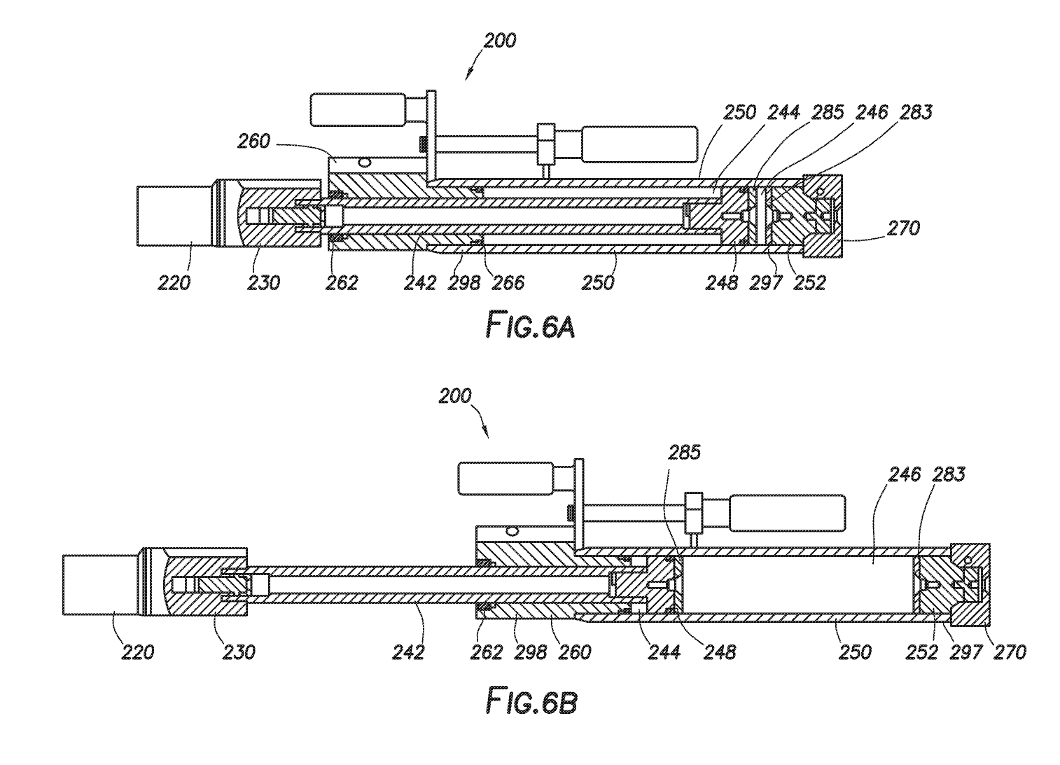

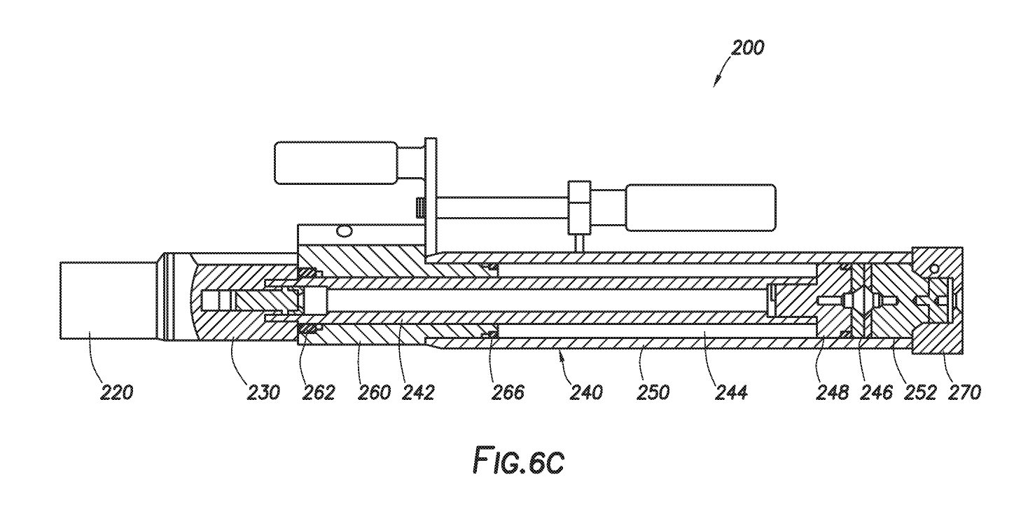

FIG. 2 depicts lightweight jack 200 in a retracted position. In certain embodiments, as discussed below with respect to FIGS. 6A, 6B, and 6C, lightweight jack 200 may have a retracted position and an extended position. Hydraulic pump 1100 may be fluidly connected to lightweight jack 200 through one or more hydraulic hoses 210. The one or more hydraulic hoses 210 may be connected to lightweight jack 200 at fluid ports 212. In certain embodiments, lightweight jack 200 may include pressure cylinder 220. Pressure cylinder 220 may be a cylinder. In some embodiments, pressure cylinder 220 may be a hollow cylinder with a section removed, forming cylinder aperture 221.

Centering lip 222 may be positioned within and attached to pressure cylinder 220. In some embodiments, centering lip 222 may be frustoconical with a section removed, forming lip aperture 223. Centering lip 222 may be hollow. Pressure cylinder 220 and centering lip 222 may be adapted to receive a portion of a tension member through pressure cylinder passage 235.

Pressure cylinder 220 may be mechanically coupled to pressure cylinder body 230 such that pressure cylinder passage 235 and cylinder body passage 232 align. “Mechanically coupled” for purposes of this disclosure, may include, but not be limited to, threaded couplings, press fitting, mechanical welding, chemical welding, friction welding, thermal coupling or welding, electrical welding, optical welding, or beam-energy welding. Pressure cylinder body 230 may be of any shape and may be a block through which cylinder body passage 232 traverses. When lightweight jack 200 is in the retracted position, pressure cylinder body 230 may abut or be positioned in proximity to extending body 260. Pressure cylinder body 230 may be mechanically coupled to hydraulic actuators 240.

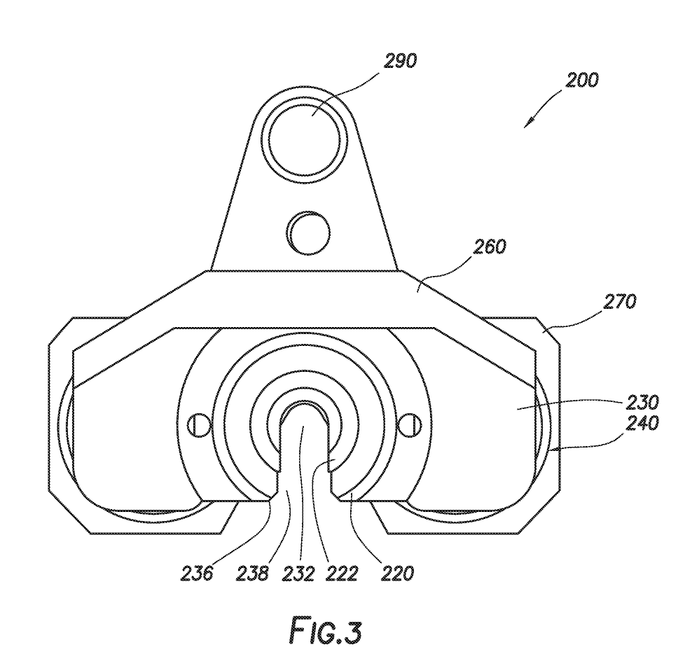

Extending body 260 may be coupled to hydraulic actuators 240. Extending body 260 may be a block of any shape having extending body passage 236 adapted to receive hydraulic actuators 240. Hydraulic actuators 240 may include inner hydraulic cylinders 242 positioned within and collinear with outer cylinders 250. Lightweight jack 200 may also include frame 270 on which hydraulic actuators 240 are mounted. FIG. 3 shows a front view of lightweight jack 200. As shown in FIG. 3, pressure cylinder passage 235, cylinder body passage 232 and extending body passage 236 are aligned to form tension member channel 238 adapted to receive a tension member.

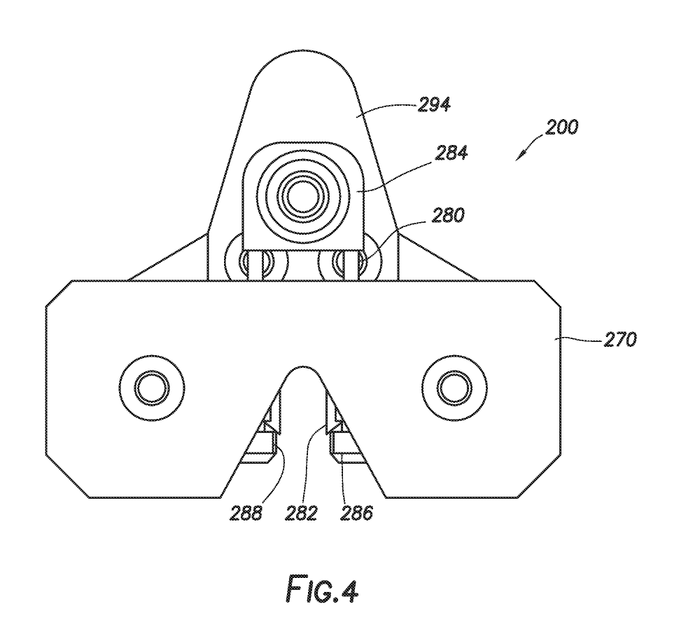

FIG. 4 shows a rear view of lightweight jack 200. Lightweight jack 200 may include strand grabbers 280. Strand grabbers 280 may be mechanically connected to extending body 260. Strand grabbers 280 are adapted to engage with a tension member. Strand grabbers 280 may engage with a tension member by such non-limiting means as scissoring, springing, or pliering together, thereby holding the tension member in place. In some embodiments strand grabbers 280 may include one or more strand grabber handles 282, a strand grabber handle cover 284, and one or more grabber blocks 286. One or more strand grabber handles 282 may be coupled to one or more grabber blocks 286. In some embodiments, strand grabbers 280 may engage the tension member at one or more grabber blocks 286. One or more grabber blocks 286 may have inner surface 288 for receiving the tension member. In some embodiments, inner surface 288 of one or more grabber blocks 286 is curved. In some embodiments, one or more grabber blocks 286 may circumferentially enclose the tension member. In some embodiments, one or more grabber blocks 286 may partially extend around a circumference of the tension member.

Strand grabbers 280 may be fixed or moveable. In certain embodiments, a fixed strand grabber 280 may be mounted to frame 270 such that fixed strand grabber 280 remains fixed with respect to frame 270. A moveable strand grabber 280 may be mounted on frame 270 such that moveable strand grabber 280 may move to engage a tension member.

As shown in FIG. 2, lightweight jack 200 may include jack handle 290 and stability bar 292. In some embodiments, stability bar 292 may be mechanically coupled to strand grabber handle cover 284 and mechanically coupled to handle mount 294. Stability bar 292 may decrease mechanical stress on or vibration of strand grabber handle 282. Stability bar 292 may include a second jack handle 296. Handle mount 294 may be coupled to extending body 260.

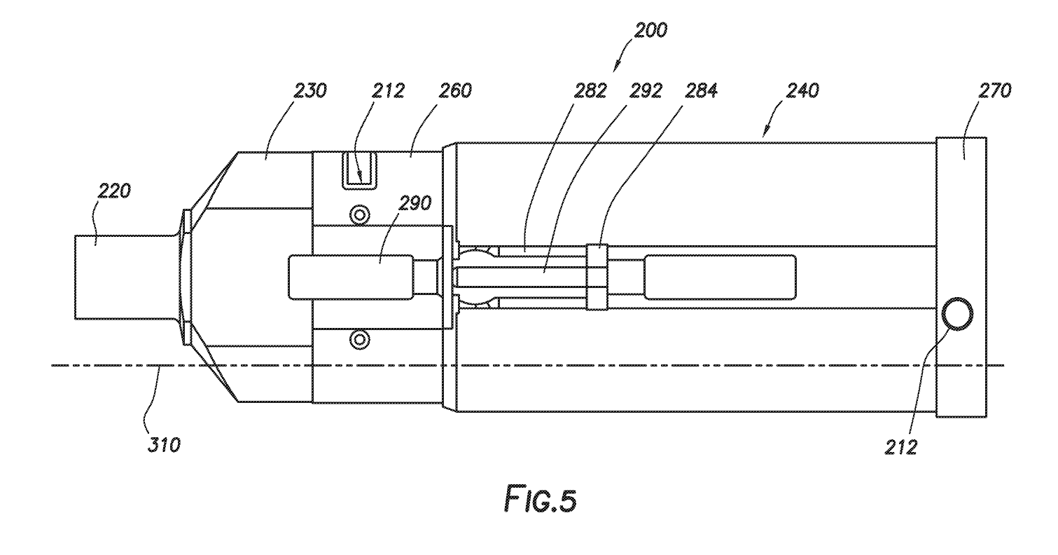

FIG. 5 shows a top-level view of lightweight jack 200. FIGS. 6A and 6C depict a cross-sectional view of lightweight jack 200 at axis 310 of FIG. 5 in a retracted position. FIG. 6B depicts a cross-sectional view of lightweight jack 200 at axis 310 of FIG. 5 in an extended position. As shown in FIGS. 6A-6C, hydraulic actuators 240 include inner hydraulic cylinder 242 positioned within outer cylinder 250. Inner hydraulic cylinder 242 is mechanically coupled to pressure cylinder body 230. Inner hydraulic cylinder 242 may be hollow. Extending body 260 may be engaged with first end 298 of outer cylinder 250 or formed as part of outer cylinder 250. One or more seals 262 may be positioned between extending body 260 and inner hydraulic cylinder 242. Frame 270 may be mechanically coupled to or fitted against second end 297 of outer cylinder 250.

Hydraulic actuator 240 may also include retraction fluid chamber 244 between inner hydraulic cylinder 242 and outer cylinder 250 and extension fluid chamber 246 between inner cylinder head 248 and outer cylinder head 252. Inner cylinder head 248 may include back plate 285. Inner cylinder head 248 may be coupled to or formed as part of inner hydraulic cylinder 242. One or more conduits may be disposed in extending body 260 and in frame 270. Retraction fluid chamber 244 may be in fluid communication with fluid port 212 on extending body 260. Extension fluid chamber 246 may be in fluid communication with fluid port 212 on frame 270. Seal 266 may be disposed between extending body 260 and outer cylinder 250. Outer cylinder head 252 may be coupled to or formed as part of outer cylinder 250. Outer cylinder head 252 may have front plate 283.

In certain embodiments, inner hydraulic cylinders 242 may be comprised of steel or other sturdy metal. The steel or other metals from which inner hydraulic cylinders 242 are composed may be heavy, i.e., of a higher density, relative to other components of lightweight jack 200. Other components of lightweight jack 200 may include, but not be limited to pressure cylinder 220, outer cylinder 250, frame 270, and strand grabbers 280. Other components of lightweight jack 200 may be composed of a light-weight metal, such as aluminum or titanium, a composite material, polymers, or carbon fiber. Examples of composite material may include fiber reinforced plastic. Fibers in fiber reinforced plastic may be composed of such materials as glass, carbon, aramid or basalt. Polymers in fiber reinforced plastic may include epoxies, vinylesters, polyester thermosetting plastics, or phenol formaldehyde resins.

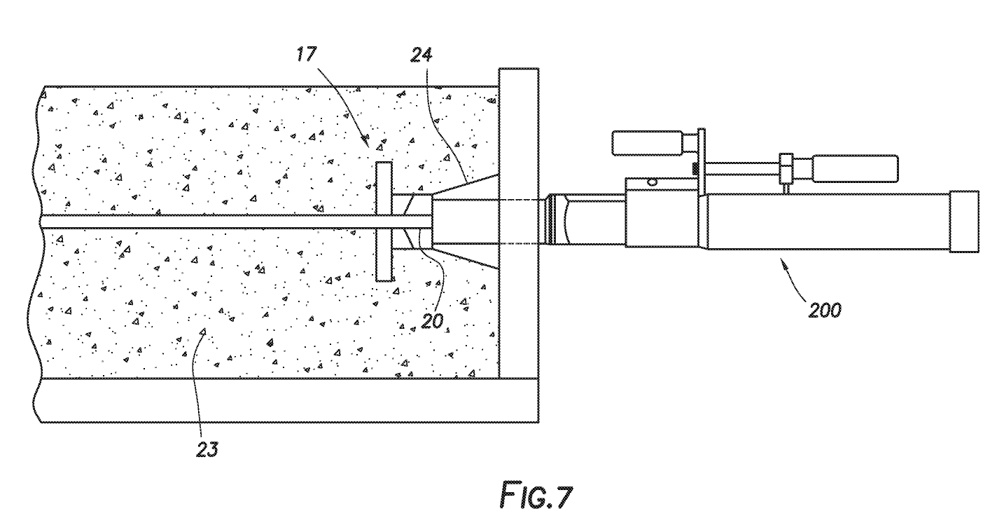

As shown in FIG. 7, during operation, lightweight jack 200 may be positioned within pocket 24 of concrete member 23. Positioned within concrete member 23 is stressing anchor 17 and tension member 20, which passes therethrough. Pressure cylinder 220 may be inserted into pocket 24 so as to abut stressing anchor 17, positioning tension member 20 within tension member channel 238. In some embodiments, pressure cylinder 220 may be mechanically connected to stressing anchor 17. Centering lip 222 may abut one or more wedges disposed within stressing anchor 17. As hydraulic pressure is applied by lightweight jack 200 as described below, pressure cylinder 220 and centering lip 222 may push the one or more wedges within stressing anchor 17, thereby holding tension member 20 in place.

In applying hydraulic pressure via lightweight jack 200, hydraulic pressure may be applied to pressure cylinder 220 through hydraulic actuators 240 to move lightweight jack 200 from a retracted position to an extended position. Hydraulic fluid may be delivered to extension fluid chamber 246 via one or more conduits in frame 270 from one or more hydraulic hoses 210 connected at fluid port 212 on frame 270. Hydraulic fluid may fill extension fluid chamber 246 causing hydraulic pressure to increase against inner cylinder head 248 and outer cylinder head 252.

Hydraulic pressure against inner cylinder head 248 is applied to pressure cylinder 220. Hydraulic pressure against outer cylinder head 252 may cause extending body 260, outer cylinder 250, outer cylinder head 252, and frame 270 to slide outwardly, away from pressure cylinder 220. As extending body 260 slides outwards, extension fluid chamber 246 may expand, filling with more hydraulic fluid. As extending body 260 slides outwards, strand grabbers 280 may pull tension member 20 through stressing anchor 17, thereby tensioning tension member 20. Hydraulic pressure of extension fluid chamber 246 may be read by pressure gauge 1120 on hydraulic pump 1100. Hydraulic pressure may be added until a preferred hydraulic pressure is reached. Hydraulic fluid may be extracted from extension fluid chamber 246 by one or more hydraulic hoses 210 connected at fluid port 212 on frame 270.

To move lightweight jack from an extended position to a retracted position, hydraulic fluid may be delivered to retraction fluid chamber 244 via one or more conduits in extending body 260 from one or more hydraulic hoses 210 connected at fluid port 212 on extending body 260. Hydraulic fluid may fill retraction fluid chamber 244 causing hydraulic pressure to increase against inner cylinder head 248 and extending body 260. Hydraulic pressure against extending body 260 and inner cylinder head 248 may cause extending body 260, outer cylinder 250, outer cylinder head 252, and frame 270 to slide inwardly, towards pressure cylinder 220. As extending body 260 slides inwardly, retraction fluid chamber 244 may expand filling with more hydraulic fluid. Hydraulic pressure of retraction fluid chamber 244 may be read by pressure gauge 1120 on hydraulic pump 1100. Hydraulic pressure may be added until a preferred hydraulic pressure is reached or outer cylinder 250 retracts around inner hydraulic cylinder 242. Hydraulic fluid may be extracted from retraction fluid chamber 244 by one or more hydraulic hoses 210 connected at fluid port 212 on extending body 260.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A lightweight jack comprising:
a pressure cylinder, the pressure cylinder having a pressure cylinder passage;
a pressure cylinder body, the pressure cylinder body being a block through which a cylinder body passage is formed, the pressure cylinder body mechanically coupled to the pressure cylinder;
a hydraulic actuator, the hydraulic actuator coupled to the pressure cylinder body, the hydraulic actuator having:
an inner hydraulic cylinder, the inner hydraulic cylinder mechanically coupled to an inner cylinder head; and
an outer cylinder, the outer cylinder mechanically coupled to an outer cylinder head;
an extending body, the extending body coupled to the hydraulic actuator, the extending body being a block through which an extending body passage is formed, wherein the pressure cylinder passage, the cylinder body passage, and the extending body passage are aligned to form a tension member channel; and
a strand grabber, the strand grabber mechanically coupled to the extending body;
wherein the pressure cylinder, outer cylinder, and strand grabber are comprised of aluminum, titanium, fiber reinforced plastic, polymers, or carbon fiber.

2. The lightweight jack of claim 1, wherein the inner cylinder head is mechanically coupled to or formed integrally with the inner hydraulic cylinder and mechanically coupled to outer cylinder head, the outer cylinder head coupled to or formed integrally with the outer cylinder.

3. The lightweight jack of claim 1, wherein the hydraulic actuator comprises:
an extension fluid chamber, the extension fluid chamber positioned between the inner cylinder head and outer cylinder head; and
a retraction fluid chamber, the retraction fluid chamber positioned between the inner cylinder head and extending body.

4. The lightweight jack of claim 1, further comprising:
a frame, the frame mechanically coupled to or fitted against the outer cylinder, the frame comprising a fluid port, and wherein the frame is comprised of aluminum, titanium, fiber reinforced plastic, polymers, or carbon fiber.

5. The lightweight jack of claim 4, wherein the strand grabber comprises:
one or more strand grabber handles; and
one or more grabber blocks, each one or more grabber blocks coupled to a grabber handle.

6. The lightweight jack of claim 5, wherein the strand grabber is fixed or moveable with respect to the frame.

7. The lightweight jack of claim 1 further comprising a centering lip, the centering lip positioned within and attached to the pressure cylinder.

8. A post-tensioning system comprising:
a concrete member;
a stressing anchor positioned within the concrete member;
a tension member, the tension member passing through the stressing anchor; and
a lightweight jack, the lightweight jack positioned so as to abut the stressing anchor, the lightweight jack including:
a pressure cylinder, the pressure cylinder having a pressure cylinder passage;
a pressure cylinder body, the pressure cylinder body being a block through which a cylinder body passage is formed, the pressure cylinder body mechanically coupled to the pressure cylinder;
a hydraulic actuator, the hydraulic actuator coupled to the pressure cylinder body, the hydraulic actuator having:
an inner hydraulic cylinder, the inner hydraulic cylinder mechanically coupled to an inner cylinder head; and
an outer cylinder, the outer cylinder mechanically coupled to an outer cylinder head;
an extending body, the extending body coupled to the hydraulic actuator, the extending body being a block through which an extending body passage is formed, wherein the pressure cylinder passage, the cylinder body passage, and the extending body passage are aligned to form a tension member channel; and
a strand grabber, the strand grabber mechanically coupled to the extending body;
wherein the pressure cylinder, outer cylinder, and strand grabber are comprised of aluminum, titanium, fiber reinforced plastic, polymers, or carbon fiber.

9. The post-tensioning system of claim 8, wherein the pressure cylinder is mechanically connected to the stressing anchor.

10. The post-tensioning system of claim 8 wherein the a lightweight jack further includes a centering lip, the centering lip positioned within and attached to the pressure cylinder and wherein the post-tensioning system further comprises one or more wedges, the one or more wedges disposed within the stressing anchor, the centering lip in abutment with at least one wedge.

11. The post-tensioning system of claim 8, wherein the tension member is positioned within the tension member channel.

12. The post-tensioning system of claim 11, wherein the strand grabber engages the tension member.

13. The post-tensioning system of claim 12, wherein the strand grabber comprises:
one or more strand grabber handles; and
one or more grabber blocks, each one or more grabber blocks coupled to a grabber handle.

14. The post-tensioning system of claim 13, wherein the one or more grabber blocks circumferentially enclose the tension member.

15. The post-tensioning system of claim 13, wherein the one or more grabber blocks partially extend around the tension member.

16. A method for post-tensioning a tension member, comprising:
supplying a concrete member;
positioning a stressing anchor within the concrete member;
passing a tension member through the stressing anchor;
positioning a lightweight jack in a retracted position about the tension member so as to abut the stressing anchor, the lightweight jack including:
a pressure cylinder the pressure cylinder having a pressure cylinder passage;
a pressure cylinder body, the pressure cylinder body being a block through which a cylinder body passage is formed, the pressure cylinder body mechanically coupled to the pressure cylinder;
a hydraulic actuator, the hydraulic actuator coupled to the pressure cylinder body, the hydraulic actuator having:
an inner hydraulic cylinder, the inner hydraulic cylinder mechanically coupled to an inner cylinder head; and
an outer cylinder, the outer cylinder mechanically coupled to an outer cylinder head;
an extending body, the extending body coupled to the hydraulic actuator, the extending body being a block through which an extending body passage is formed, wherein the pressure cylinder passage, the cylinder body passage, and the extending body passage are aligned to form a tension member channel; and
a strand grabber, the strand grabber mechanically coupled to the extending body;
wherein the pressure cylinder, outer cylinder, and strand grabber are comprised of aluminum, titanium, fiber reinforced plastic, polymers, or carbon fiber;
engaging the tension member with the strand grabber; and
moving the lightweight jack from a retracted position to an extended position so as to tension the tension member.

17. The method of claim 16, wherein the step of moving the lightweight jack from a retracted position to an extended position comprises applying hydraulic pressure to the pressure cylinder through the hydraulic actuator.

18. The method of claim 16, wherein the hydraulic actuator comprises:
an extension fluid chamber, the extension fluid chamber positioned between the inner cylinder head and outer cylinder head; and
a retraction fluid chamber, the retraction fluid chamber positioned between the inner cylinder head and extending body.

19. The method of claim 18, wherein the step of moving the lightweight jack from a retracted position to an extended position comprises:
filling the extension fluid chamber with hydraulic fluid to increase the hydraulic pressure against the inner cylinder head and the outer cylinder head; and
sliding the extending body.

20. The method of claim 19, wherein the step of moving the lightweight jack from a retracted position to an extended position further comprises:
pulling the tension member through the stressing anchor with the strand grabbers.
